(19) United States
(12) Patent Application Publication
(10) Pub. No.: US 2010/0153974 A1
(43) Pub. Date: Jun. 17, 2010

(54) OBTAIN BUFFERS FOR AN INPUT/OUTPUT DRIVER

(75) Inventors: Omar Cardona, Cedar Park, TX (US); James B. Cunningham, Austin, TX (US); Baltazar De Leon, III, Autin, TX (US); Jeffrey P. Messing, Round Rock, TX (US)

Correspondence Address: IBM Corp. (AUS/RCR);c/o The Rolnik Law Firm, P.C., 24 N. Main St., Kingwood, TX, 77339, US

(73) Assignee: International Business Machines Corporation, Armonk, NY (US)

(21) Appl. No.: 12/335,612

(22) Filed: Dec. 16, 2008

(51) Int. Cl. G06F 9/44

(52) U.S. Cl. 719/321

(57) ABSTRACT

Disclosed is a computer implemented method, computer program product, and apparatus to obtain buffers in a multiprocessor system. A software component receives a call from an I/O device driver for a buffer, the call including at least one parameter, and walks a bucket data structure to a current bucket. The software component then determines whether the current bucket is free, and obtains a buffer list contained with the current bucket. Responsive to a determination that the current bucket is free, the software component determines whether sufficient buffers are obtained based on the parameter. Upon determining there are sufficient buffers obtained, the software component provides the current bucket and a second bucket as a single buffer list to the I/O device driver.

### BACKGROUND OF THE INVENTION

1. Field of the Invention

The present invention relates generally to a computer implemented method, data processing system, and computer program product for allocating memory for communication functions. More specifically, the present invention relates to allocating buffers from a buffer pool in a memory-locking environment.

2. Description of the Related Art

Dynamic memory allocation is the art and methodology of obtaining enough memory for a currently running application, or other software component, at such times as the application requests memory blocks, and returning such memory to the heap in response to the application terminating use of the applicable blocks. In contrast, static memory allocation is the art of initializing and allocating blocks of memory early in program operation to account for a ‘worst case’ need of the application, and then yielding back such memory to the heap at the termination of the application. One example, of static memory allocation is the use of fixed size array use. A dynamic memory allocator or scheme performs at least two functions. The first function is tracking blocks that are in use. The second function is tracking which blocks are free.

Computer systems frequently rely on network data connections to interoperate with other computers. Networked computers have been used in many architectures and business models. Data rates of common network elements are continuously being enhanced and redefined to meet new standards for speed and reliability. To satisfy higher data rate requirements, some computer architectures rely upon a network subsystem.

A memory pool is a physical memory managed by a memory allocator to satisfy requests by software components for memory. Software components can be, for example, drivers, applications, operating systems, and the like. A memory pool can be a dedicated memory pool, such as, for example, buffers, or mbufs as used in networking applications.

A network subsystem uses memory management facilities to provide readily available physical memory to buffer incoming and outgoing data streams. An mbuf is a unit of memory provided for this purpose. An mbuf or memory buffer is used to store data in the kernel for incoming and outbound network traffic. Mbufs always reside in physical memory. Consequently, mbufs are never paged out.

A network service periodically needs to transport data. At this time, the network service can call an operating system mbuf allocator. An operating system mbuf allocator is a service that locks a pool of memory set aside for mbufs during a memory allocation operation. A buffer pool is one of one or more portions of memory set aside for networking operations. Each mbuf of the buffer pool can be used by a layer of a networking protocol stack to manipulate data being sent or received from a network port.

Designers of memory allocators have, within parallel environments, attempted, with varying success, to reduce single threading the memory allocation needs of the overall data processing system. Accordingly, if bottlenecks in this area were reduced, more efficiency in general program execution might be obtained in multi-threading environments.

### SUMMARY OF THE INVENTION

The present invention provides a computer implemented method, computer program product, and apparatus to obtain buffers in a multiprocessor system. A software component receives a call from an I/O device driver for a buffer, the call including at least one parameter, and walks a bucket data structure to a current bucket. The software component then determines whether the current bucket is free, and obtains a buffer list contained with the current bucket. Responsive to a determination that the current bucket is free, the software component determines whether sufficient buffers are obtained based on the parameter. Upon determining there are sufficient buffers obtained, the software component provides the current bucket and a second bucket as a single buffer list to the I/O device driver.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in accordance with an illustrative embodiment of the invention;

FIG. 2A is a diagram of software components that communicate in accordance with an illustrative embodiment of the invention;

FIG. 2B is a diagram of a mbuf list before adding an additional mbuf in accordance with an illustrative embodiment of the invention;

FIG. 2C is a diagram of a mbuf list after adding an additional mbuf in accordance with an illustrative embodiment of the invention;

FIG. 3 is a diagram of software components operating on a series of buckets in accordance with an illustrative embodiment of the invention;

FIG. 4A is a flowchart of initializing a bucket accordance with an illustrative embodiment of the invention;

FIG. 4B is a flowchart of collect freed mbufs to a bucket in accordance with an illustrative embodiment of the invention;

FIG. 4C is a flowchart of allocating an mbuf list to an I/O device driver in accordance with an illustrative embodiment of the invention;

FIG. 5A shows an order of walking a bucket data structure in accordance with an illustrative embodiment of the invention;

FIG. 5B shows a second order of walking a bucket data structure in accordance with an illustrative embodiment of the invention; and

FIG. 5C shows a third order of walking a bucket data structure in accordance with an illustrative embodiment of the invention.

### DETAILED DESCRIPTION OF THE PREFERRED EMBODIMENT

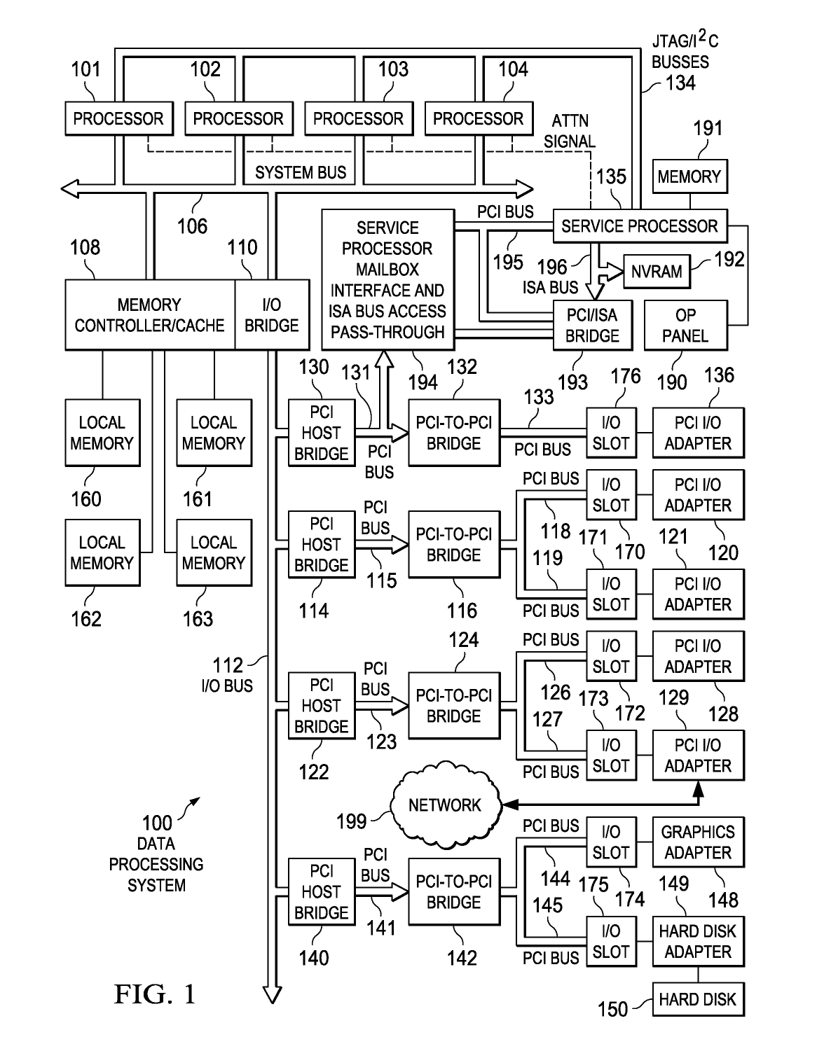

FIG. 1 shows a block diagram of a data processing system in which illustrative embodiments of the invention may be implemented. Data processing system 100 may be a multiprocessor system, such as a symmetric multiprocessor (SMP) system including a plurality of processors 101, 102, 103, and 104, which connect to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 connects to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems or multiple instances of a single operating system running simultaneously. Each of these multiple operating systems may have any number of software programs executing within it. Data processing system 100 is logically partitioned such that different PCI I/O adapters 120,121, 128,129, and 136 may be assigned to different logical partitions.

Thus, for example, suppose data processing system 100 is divided into three logical partitions, P1, P2, and P3. Each of PCI I/O adapters 120, 121, 128, 129, 136, each of processors 101-104, and memory from local memories 160-163 is assigned to each of the three partitions. In these examples, local memories 160-163 may take the form of dual inline memory modules (DIMMs). DIMMs are not normally assigned on a per DIMM basis to partitions. Instead, a partition will get a portion of the overall memory seen by the platform. For example, processors 102-103, some portion of memory from local memories 160-163, and PCI I/O adapters 121 and 136 may be assigned to logical partition P2; and processor 104, some portion of memory from local memories 160-163 may be assigned to logical partition P3.

Each operating system executing within data processing system 100 is assigned to a different logical partition. Thus, each operating system executing within data processing system 100 may access only those I/O units that are within its logical partition. For example, one instance of the Advanced Interactive Executive (AIX®) operating system may be executing within partition P1, a second instance or image of the AIX® operating system may be executing within partition P2, and a Linux® operating system may be operating within logical partition P3. AIX® is a registered trademark of International Business Machines Corporation. Linux® is a registered trademark of Linus Torvalds.

Peripheral component interconnect (PCI) host bridge 114 connected to I/O bus 112 provides an interface to PCI local bus 115. A number of PCI input/output adapters 120-121 connect to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters, that is, expansion slots for add-in connectors. Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128-129. PCI I/O adapters 128-129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers across network 199.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141. Hard disk adapter 149 connects to and controls hard disk 150.

A PCI host bridge 130 provides an interface for a PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through 194 forwards PCI accesses destined to the PCI/ISA bridge 193. NVRAM storage 192, also known as non-volatile RAM, connects to ISA bus 196. Service processor 135 connects to service processor mailbox interface and ISA bus access pass-through 194 through its local PCI bus 195. Service processor 135 also connects to processors 101-104 via a plurality of JTAG/I²C busses 134. JTAG/I²C busses 134 are a combination of JTAG/scan busses, as defined by Institute for Electrical and Electronics Engineers standard 1149.1, and Philips I²C busses. However, alternatively, JTAG/I²C busses 134 may be replaced by only Philips I²C busses or only JTAG/scan busses. All SP-ATTN signals of the processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I²C busses 134 to interrogate the system processors 101-104, then memory controller/cache 108 and I/O bridge 110 via system bus 106. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating processors 101-104, memory controller/cache 108, and I/O bridge 110. Any error information for failures detected during the BISTs, BATs, and memory tests are gathered and reported by service processor 135.

If a meaningful or valid configuration of system resources is still possible after taking out the elements found to be faulty during the BISTs, BATs, and memory tests, then data processing system 100 is allowed to proceed to load executable code into local memories 160, 161, 162, and 163. Service processor 135 then releases processors 101-104 for execution of the code loaded into local memories 160-163. While processors 101-104 are executing code from respective operating systems within data processing system 100, service processor 135 enters a mode of monitoring and reporting errors. The type of items monitored by service processor 135 includes, for example, the cooling fan speed and operation, thermal sensors, power supply regulators, and recoverable and non-recoverable errors reported by processors 101-104, local memories 160-163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and determine that this condition is predictive of a hard failure. Based on this determination, service processor 135 may mark that processor or other resource for deconfiguration during the current running session and future Initial Program Loads (IPLs). IPLs are also sometimes referred to as a “boot” or “bootstrap.”

Data processing system 100 may be implemented using various commercially available computer systems. For example, data processing system 100 may be implemented using IBM eServer iSeries® Model 840 system available from International Business Machines Corporation. Such a system may support logical partitioning, wherein an OS/400® operating system may exist within a partition. iSeries® and OS/400® are registered trademarks of International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example does not imply architectural limitations with respect to embodiments of the present invention.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The aspects of the illustrative embodiments provide a computer implemented method, data processing system, and computer program product for enhanced throughput in freeing buffers used, for example, in high-speed data communication. For example, one or more embodiments may minimize single threading and avoid heap contention. Heap contention occurs when two threads try to access data at the same time, and one thread must wait for the other thread to complete. Accordingly, a system may achieve better responsiveness when serving clients, or alternatively, when resetting hardware in response to freeing all buffers in a system.

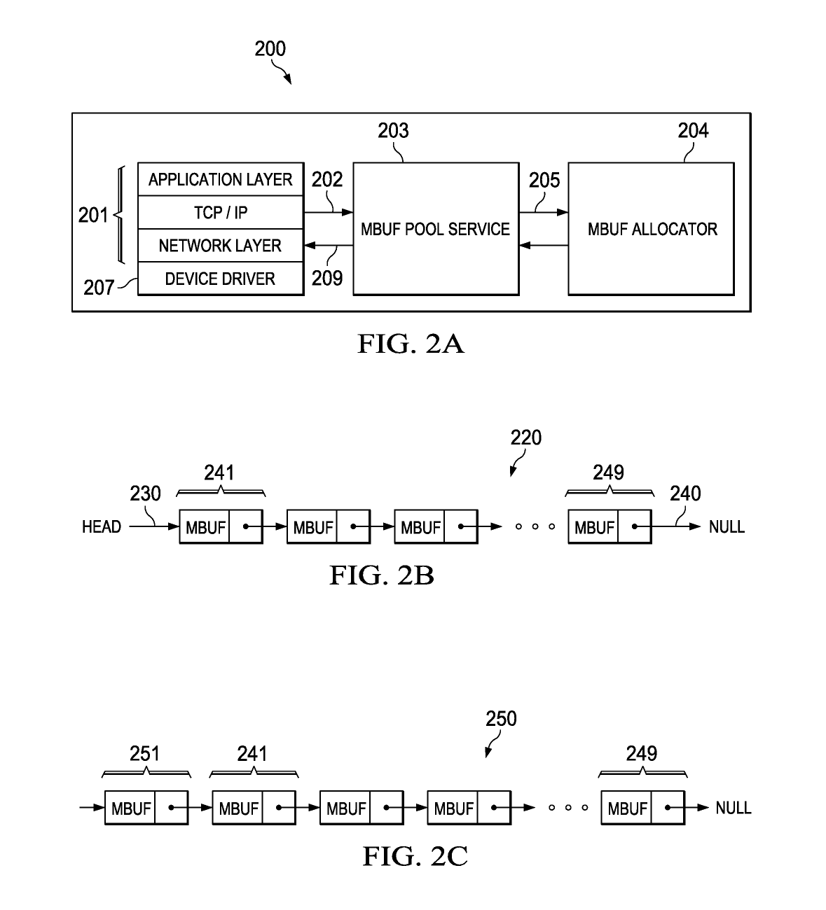

FIG. 2A shows a diagram of software components 200 that communicate in accordance with an illustrative embodiment of the invention. Protocol stack 201 may be a combination of kernel space and user-space software components that interact with network 205 to accomplish communication function. The memory and processors allocated to performing the functions of protocol stack 201 may be, for example, one or more of memory 191, NVRAM 192, local memory 160-163, and processors 101-104, respectively. One example of a protocol stack is the protocol stack in AIX® data processing systems. Protocol stack 201 communicates via service call 202 with mbuf pool service 203 to obtain an mbuf as a pointer 209 to each mbuf requested. An I/O device driver is computer instructions operating on one or more processors that permit a matching physical device to provide communication functions to other software components, for example, a logical partition. The I/O device driver may be I/O device driver 207 and the matching physical device may be, for example, PCI I/O adapter 136 of FIG. 1.

Mbuf pool service 203, in turn, can make calls to mbuf allocator 204 to obtain mbuf lists, as needed. Mbuf allocator 204 can be, for example, a modified m_get_from_clustpool( ) function as described in U.S. patent application Ser. No. 12/057,852, herein incorporated by reference. The modified m_get_from_clustpool( ) function is modified to determine a number of mbufs requested, and in response thereto, provide, to the extent available, the number of mbufs requested. The mbuf allocator can iteratively reference the pointer of one node to the content of a subsequent node to create an mbuf list.

Mbuf pool service 203 can obtain one buffer linked list or buffer list at a time from mbuf allocator 204. A buffer list is a linked list of buffers. In addition, an mbuf list is a linked list of mbufs. In the examples that follow, the mbuf linked list is used as a specific example of a buffer linked list or buffer list. For example, mbuf pool service 203 can obtain an mbuf list derived from a common pool or buffer pool of linked lists. An mbuf list can be a sub-pool of a dedicated pool of memory for a particular function, for example, networking applications. Each of these linked lists may be allocated to transmit functions or receive functions, respectively, of protocol stack 201. A call from mbuf pool service 201 to mbuf allocator 204 may begin with mbuf pool service 203 making a request to obtain mbufs 205. Mbuf allocator 204, may respond to such a request by providing a link to an mbuf list having multiple mbufs. The operation of software components 200, such as, for example, mbuf pool service 203 and operating system mbuf allocator 204 may be executed by one or more processes executing on processor 101 through processor 104 of FIG. 1. It is appreciated that alternative buffers may be used to mbufs. For example, the skbuff network memory buffer structures can be used as a buffers in Linux operating systems.

FIG. 2B shows an mbuf list in accordance with an illustrative embodiment of the invention. Mbuf list 220 is sometimes called an mlist. The mbuf list comprises pointer 230 to head node 241. Head node 241 is comprised of an mbuf and a pointer to the next node in the mbuf list. The mbuf list may be of an arbitrary size, and ends with last node 249. Last node 249, like all other nodes in the mbuf list, has a pointer. The last node's pointer is null reference 240.

FIG. 2C shows a second mbuf list in accordance with an illustrative embodiment of the invention. Second mbuf list 250 is the same as the mbuf list of FIG. 2B, except that the second mbuf list has additional node 251 added to the head of the list, thus replacing node 241 has the head node of the mbuf list. The mbuf list may be of an arbitrary size, and ends with last node 249.

A bucket data structure is a finite number of mbufs that are a contiguous subset of mbufs within an mbuf list. The bucket data structure may include references associated with each mbuf that point to further mbufs in an mbuf list. The bucket data structure can include a head node of an mbuf list.

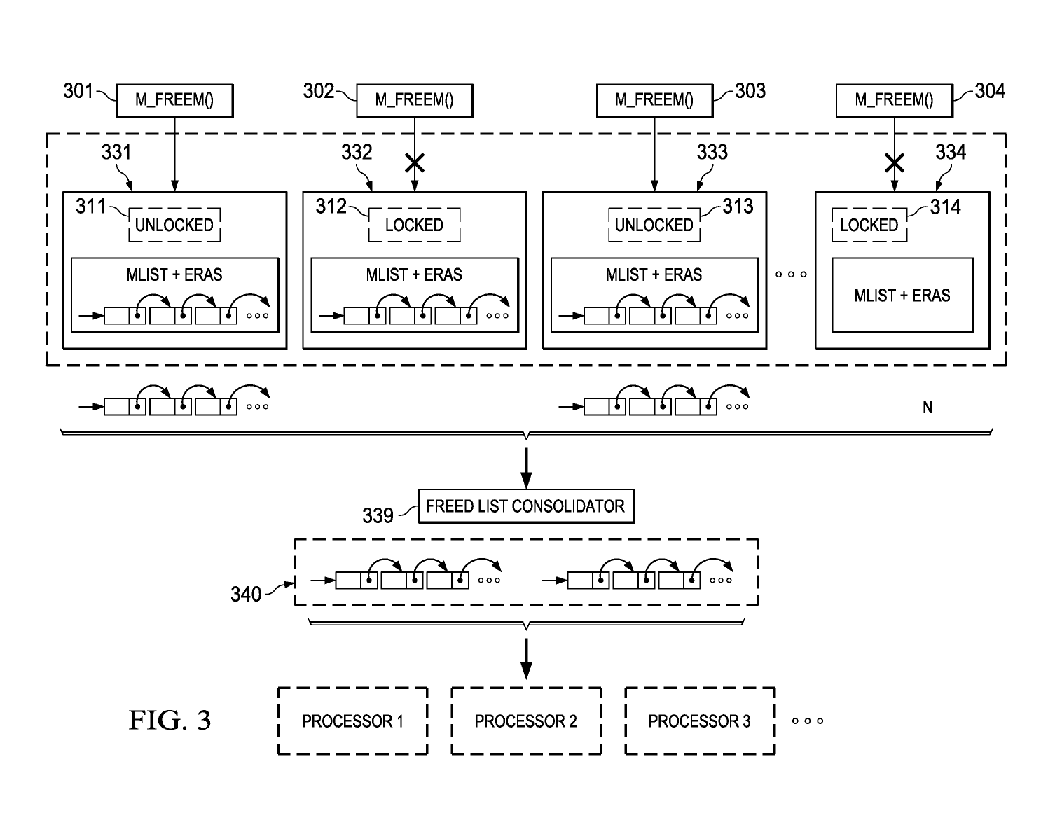

FIG. 3 is a diagram of software components operating on a series of buckets in accordance with an illustrative embodiment of the invention. In general, multiple software components may operate concurrently on a multiprocessor system. Instances of m_freem, explained below, routinely free mbuf lists and insert any such mbuf list into a segment of an mbuf list contained by a bucket 331, bucket 332, bucket 333, bucket 334, and any other buckets of the data processing system.

Bucket 331 is a first ordinal bucket. The first ordinal bucket in a list of buckets is the bucket that is at the head of a list of buckets. The buckets can be nodes in a linked list. Remaining buckets, for example, bucket 332, bucket 333, and bucket 334 are secondary buckets. A secondary bucket is any bucket in the bucket data structure other than the first ordinal bucket, for example, second ordinal bucket, bucket 332, and third ordinal bucket, bucket 333. Accordingly, the secondary bucket does not include a head to the bucket data structure. The bucket that the secondary bucket points to is a bucket following the secondary bucket, as are the buckets to which that bucket points. A secondary bucket does not include a head to the bucket data structure. Each bucket has an associated lock. The lock may be implemented as a bit that is alternatively set to 0 or to 1 to signal that the lock is, respectively, unlocked or locked. For example, bucket 331 has unlocked bit 311, bucket 332 has locked bit 312, bucket 333 has unlocked bit 313, and bucket 334 has locked bit 314. It is appreciated that although FIG. 3 shows four buckets, more or fewer buckets may be present in bucket data structure. The number of buckets, N, may be more than there are processors in the data processing system. Accordingly, at least one bucket will be unlocked and discovered during the walking process. Each mbuf may have a correlator or identifier that indicates the bucket with which the mbuf is associated.

A feature of one or more embodiments of the invention can include a software component for obtaining the portion of the mbuf list that exists in unlocked buckets and linking such portions so obtained as a single mbuf list. A single buffer list is a contiguous list of buffers in a linked list. In addition, a single mbuf list is a contiguous list of mbufs in a linked list. The mbufs themselves are not necessarily contiguous in memory. However, each node in the single mbuf list is pointed to by another node in the list. The software component may be freed list consolidator 339. A freed list consolidator 339 is a software component that walks or otherwise traverses nodes in an mbuf list and collects mbufs for allocation to the processors. Accordingly, freed list consolidator 339 may provide single mbuf list 340 to processors 101-104 of FIG. 1.

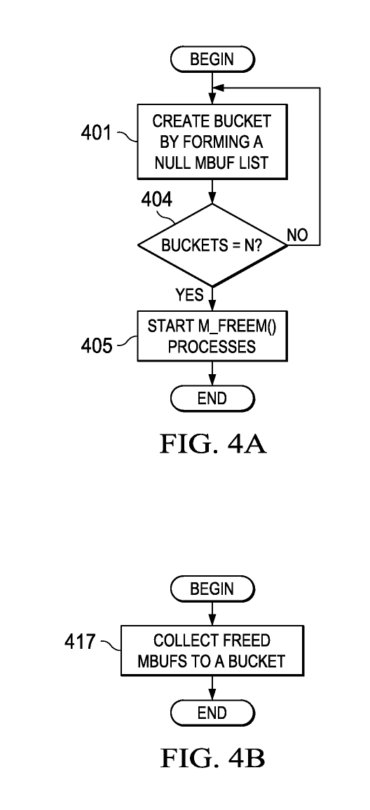

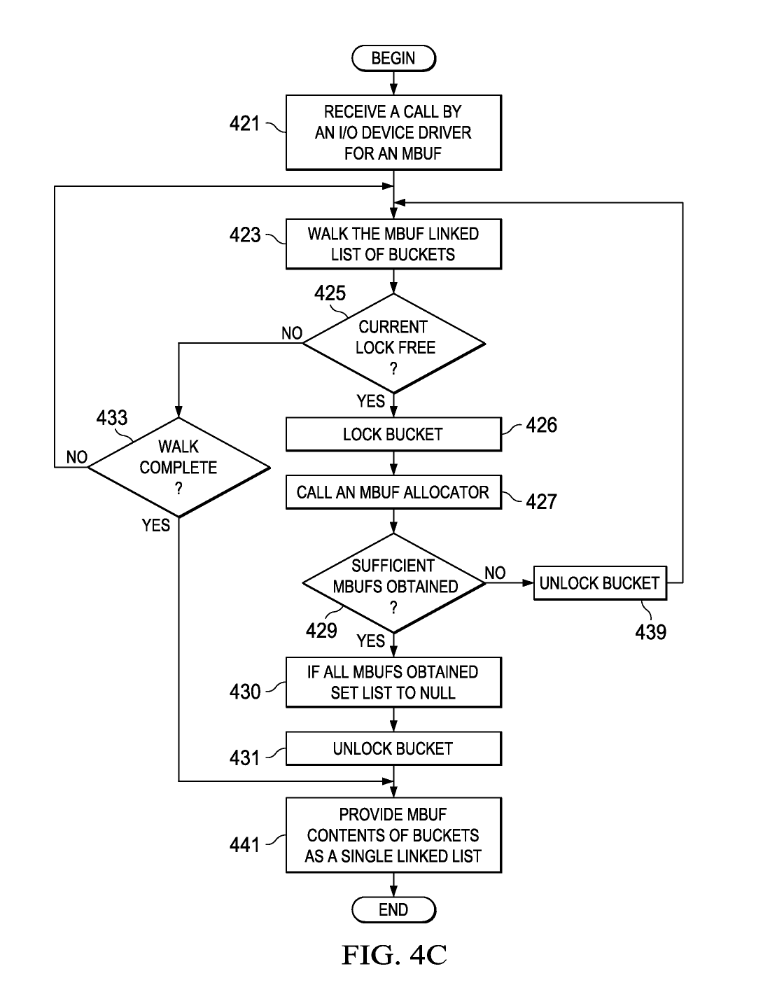

FIGS. 4A-4C describe buffer allocation in terms of mbufs and mbuf lists. However, as can be appreciated, the steps of FIGS. 4A-4C may be equally applied to any form of buffer allocated and managed by, for example, parallel memory allocators. Accordingly, the following illustrative embodiments are set forth merely as examples of one or more ways to accomplish various features. Moreover, an mbuf pool service is a specific embodiment of a more generalized buffer pool service, which is within the scope of the embodiments presented herein.

FIG. 4A is a flowchart of steps to initialize a bucket in accordance with an illustrative embodiment of the invention. As explained above, with reference to FIG. 2B, an mbuf list can be a sub-pool of a dedicated pool of memory. Accordingly, the steps of FIGS. 4A, 4B and 4C, below, may equally be applied to any sub-pool of a dedicated pool of memory. Initially, the data processing system creates a bucket by forming a null mbuf list (step 401). As part of step 401, the data processing system may associate each bucket with an unlocked lock. In addition, the data processing system may provide a reliability, availability, and serviceability (RAS) data structure associated with each bucket. Further as part of step 401, to the extent additional buckets already exist; the data processing system may link such buckets to the presently formed bucket. Next, the data processing system may determine if the buckets have reached a predetermined threshold count or ‘N’ (step 404). If the number of buckets created at step 401 is not at the threshold count, the data processing system may iterate to create and link additional buckets to the bucket data structure by repeating step 401. The predetermined threshold count or ‘N’ is any number that is equal to or greater than the number of processors. In the example of FIG. 1, N is four or greater. Alternatively, the data processing system may start m_freem software components, if the bucket numbers equals N (step 405). M_freem is a software component that is configured to free an mbuf to a bucket. The number of concurrent m_freem instances may be as much as the number of processor threads in a data processing system. The process terminates thereafter.

FIG. 4B is a flowchart of steps to collect freed mbufs to a bucket in accordance with an illustrative embodiment of the invention. The steps of FIG. 4B can be performed by a software component. The software component can be a kernel service that returns an mbuf structure to the buffer pool. The software component can be m_free or m_freem as described in AIX Version 6.1. Instances of m_freem are depicted, for example, by m_freem( ) 301, m_freem( ) 302, m_freem( ) 303 and m_freem( ) 304 of FIG. 3. Each m_freem collects freed mbufs to a bucket (step 417). Each software component operates concurrently. The process terminates thereafter.

FIG. 4C is a flowchart of allocating an mbuf list to an I/O device driver in accordance with an illustrative embodiment of the invention. Initially, a freed list consolidator receives a call by an I/O device driver for one or more mbufs (step 421). A freed list consolidator may be freed list consolidator 339 of FIG. 3. The I/O device driver can pass a parameter for a specified number of mbufs. A parameter is a value passed from a first software component to a second software component in order for the second software component to perform a specialized function based on the value. The parameter may be placed in a data structure used to support a call from the first software component to the second software component. Some software components, in response to a call, can update or otherwise change the parameter.

Alternatively, the I/O device driver can pass a parameter to indicate that all mbufs are required. Such a parameter is a value representing all mbufs. Next, the freed list consolidator may walk the mbuf linked list of buckets (step 423). Walking the linked list of buckets may comprise advancing a pointer from one bucket to another. In other words, a pointer may initially point to bucket 331 of FIG. 3. After walking to a next bucket, the pointer may point to, for example, bucket 332, a secondary bucket. Buckets that remain, for example, bucket 333 and bucket 334 are buckets following the secondary bucket. Walking entails making each successive bucket of the bucket list a current bucket such that if the tail of the bucket list is reached, and further buckets remain to be walked (during this traversal), the head of the bucket list is made current. In other words, each bucket is traversed in sequence.

Next, the freed list consolidator may determine if a current lock is free (step 425). The current lock is a lock associated with the current bucket. The lock can be a bit setting, for example, 1 to indicate that the associated bucket is locked. If the lock indicates that the bucket is free, freed list consolidator may lock the bucket (step 426). Next, freed list consolidator may perform or otherwise call an mbuf allocator (step 427). An mbuf allocator is a software component that allocates mbufs. M_get_from_clustpool is an mbuf allocator, for example, the m_get_from_clustpool( ) function of the AIX® operating system.

Next, freed list consolidator determines whether sufficient buffers or other pooled memory structures have been obtained (step 429). Buffers or pooled memory structures can be, for example, mbufs, as illustrated in FIG. 2B. Sufficient buffers is a number of buffers that meets or exceeds a) a threshold number of mbufs equal to a parameter passed to a freed list consolidator or b) all mbufs of the data processing system. The threshold number can be all mbufs, which can be expressed by using a user tunable value as a parameter. If insufficient buffers, such as mbufs, have been obtained, a freed list consolidator may unlock the bucket (step 439). A freed list consolidator may iterate by repeating step 423 and those steps that follow.

However, if sufficient buffers or mbufs have been obtained, a freed list consolidator may, on the condition that all buffers or mbufs are obtained, set the linked list of buckets to null (step 430). Next, a freed list consolidator unlocks the bucket (step 431).

If the current lock is not free (step 425), the mbuf linked list of buckets walked is determined if complete (step 433). A negative determination returns the process to step 423 for a continued processing. At the positive outcome to step 433 (walk complete), a freed list consolidator provides the mbuf contents of buckets walked and found unlocked (full m_get_from_clustpool outputs) as a single linked list (step 441). Such a list is shown as single mbuf list 340 of FIG. 3. The single mbuf list can include the content of a current bucket and another or second bucket. A freed list consolidator can provide the single mbuf list to the device driver, and accordingly, to processors 101-104 that may be executing the code of the device driver. The process terminates thereafter.

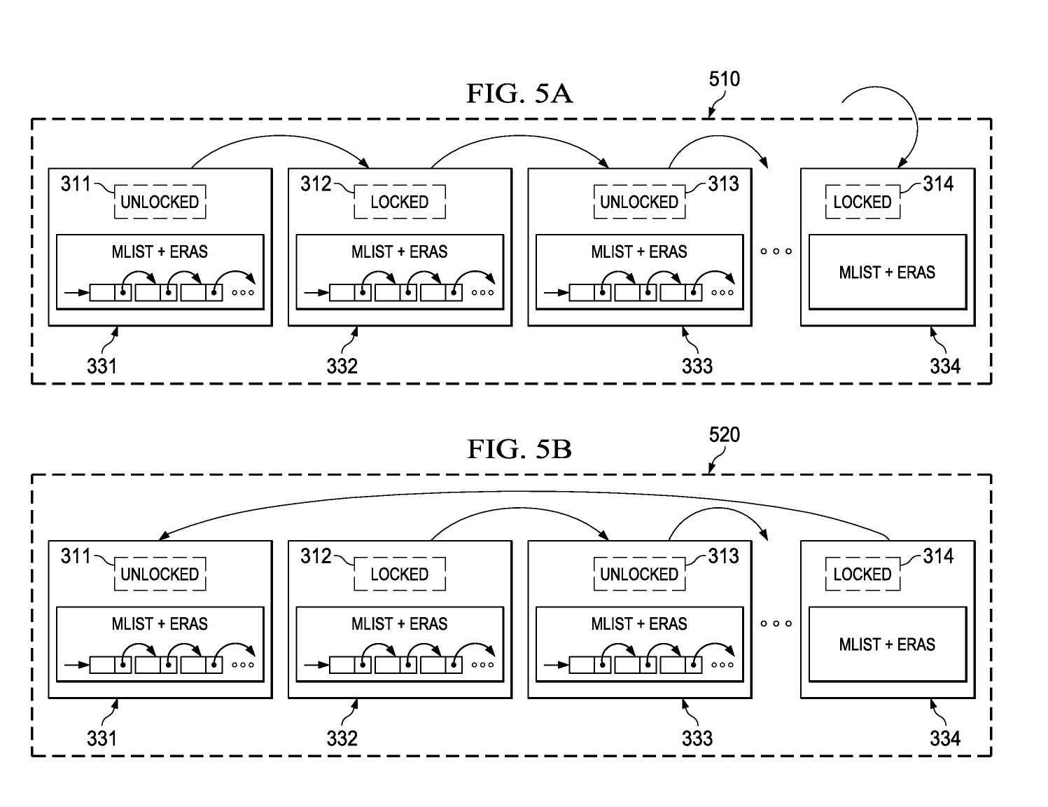

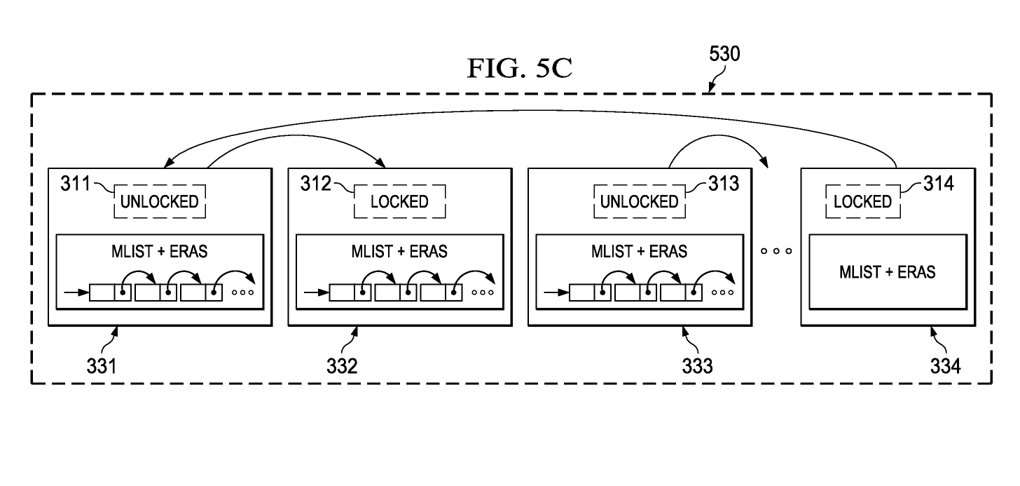

FIG. 5A shows an order of walking a bucket data structure in accordance with FIG. 3, an illustrative embodiment of the invention. Order 510 comprises walking to bucket 331, followed by walking to bucket 332, bucket 333, any intervening buckets and bucket 334.

FIG. 5B shows a second order of walking a bucket data structure in accordance with FIG. 3, an illustrative embodiment of the invention. Order 520 comprises walking to bucket 332, followed by walking to bucket 333, any intervening buckets, bucket 334, and bucket 331.

FIG. 5C shows a third order of walking a bucket data structure in accordance with FIG. 3, an illustrative embodiment of the invention. Order 530 comprises walking to bucket 333, followed by walking to any intervening buckets, bucket 334, bucket 331 and bucket 332.

The illustrative embodiments may enhance throughput in freeing mbufs or buffers used, for example, in high-speed data communication. Accordingly, a system may achieve better responsiveness when serving clients, or alternatively, when resetting hardware in response to freeing all buffers in a system.

Although the methods and apparatus described herein describe memory allocation in terms of mbufs, it is appreciated that any form buffer within any form of pooled memory may be allocated using the techniques and machines described above.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method to obtain buffers in a multiprocessor system, the method comprising:
receiving a call from an I/O device driver for a buffer, the call including at least one parameter;
walking a bucket data structure to a current bucket;
determining whether the current bucket is free;
responsive to a determination that the current bucket is free, obtaining a buffer list contained with the current bucket;
determining whether sufficient buffers are obtained based on the parameter; and
responsive to a determination that sufficient buffers are obtained, providing the current bucket and a second bucket as a single buffer list to the I/O device driver.

2. The computer implemented method of claim 1 wherein the bucket data structure comprises a linked list of buffers and walking the bucket data structure walks each bucket in sequence.

3. The computer implemented method of claim 1, wherein walking the bucket data structure comprises:
first walking a secondary bucket; and
responsive to first walking the second ordinal bucket, second walking a third ordinal bucket.

4. The computer implemented method of claim 3, wherein the secondary bucket does not include a head to the bucket data structure.

5. The computer implemented method of claim 3, wherein the bucket data structure comprises more buckets than are processors present in the multiprocessor system.

6. The computer implemented method of claim 3, wherein the parameter is a value representing all buffers.

7. The computer implemented method of claim 3, wherein the parameter is a value representing a whole number of buffers.

8. A computer program product to obtain buffers in a multiprocessor system, the computer program product comprising:
a computer usable medium having computer usable program code embodied therewith, the computer program product comprising:
computer usable program code configured to receive a call from an I/O device driver for a buffer, the call including at least one parameter;
computer usable program code configured to walk a bucket data structure to a current bucket;
computer usable program code configured to determine whether the current bucket is free;
computer usable program code configured to obtain a buffer list contained with the current bucket, responsive to a determination that the current bucket is free;
computer usable program code configured to determine whether sufficient buffers are obtained based on the parameter; and
computer usable program code configured to provide the current bucket and a second bucket as a single buffer list to the I/O device driver, responsive to a determination that sufficient buffers are obtained.

9. The computer program product of claim 8 wherein the bucket data structure comprises a linked list of buffers and walking the bucket data structure walks each bucket in sequence.

10. The computer program product of claim 8, wherein walking the bucket data structure comprises:
first walking a secondary bucket; and
second walking a third ordinal bucket, responsive to first walking the second ordinal bucket.

11. The computer program product of claim 10, wherein the secondary bucket does not include a head to the bucket data structure.

12. The computer program product of claim 10, wherein the bucket data structure comprises more buckets than are processors present in the multiprocessor system.

13. The computer program product of claim 10, wherein the parameter is a value representing all buffers.

14. The computer program product of claim 10, wherein the parameter is a value representing a whole number of buffers.

15. A data processing system comprising:
a bus;
a storage device connected to the bus, wherein computer usable code is located in the storage device;
a communication unit connected to the bus; and
a processing unit connected to the bus, wherein the processing unit executes the computer usable code for obtaining buffers in a multiprocessor system, wherein the processing unit executes the computer usable program code to receive a call from an I/O device driver for a buffer, the call including at least one parameter; walk a bucket data structure to a current bucket; determine whether the current bucket is free; obtain a buffer list contained with the current bucket, responsive to a determination that the current bucket is free; determine whether sufficient buffers are obtained based on the parameter; and provide the current bucket and a second bucket as a single buffer list to the I/O device driver, responsive to a determination that sufficient buffers are obtained.

16. The data processing system claim 15 wherein the bucket data structure comprises a linked list of buffers and walking the bucket data structure walks each bucket in sequence.

17. The data processing system claim 15, wherein walking the bucket data structure comprises:
first walking a secondary bucket; and
second walking a third ordinal bucket, responsive to first walking the second ordinal bucket.

18. The data processing system claim 17, wherein the secondary bucket does not include a head to the bucket data structure.

19. The data processing system claim 17, wherein the bucket data structure comprises more buckets than are processors present in the multiprocessor system.

20. The data processing system claim 17, wherein the parameter is a value representing all buffers.
